(19) United States
(12) Patent Application Publication
(10) Pub. No.: US 2017/0018938 A1
(43) Pub. Date: Jan. 19, 2017

(54) APPARATUS, A SYSTEM, A COMPUTER PROGRAM PRODUCT AND A METHOD FOR SIGNALLING BETWEEN AN ACCESSORY AND AN APPARATUS

(71) Applicant: NOKIA TECHNOLOGIES OY, Espoo (FI)

(72) Inventors: Juhani KARI, Lieto (FI); Timo TOIVOLA, Turku (FI)

(21) Appl. No.: 15/123,852

(22) PCT Filed: Mar. 4, 2015
(86) PCT No.: PCT/FI2015/050135

§ 371 Date: Sep. 6, 2016

(30) Foreign Application Priority Data
Mar. 13, 2014 (FI) 20145231

(51) Int. Cl. H02J 7/00; H02J 7/02; H04M 1/725

(52) U.S. Cl. CPC H02J 7/0008; H04M 1/72527; H02J 7/025

(57) ABSTRACT

The invention relates to an apparatus, to an accessory, to methods and computer program products for them, and to a system comprising the apparatus and the accessory. The apparatus comprises at least one processor, memory including computer program code. The accessory comprises an interface with at least one power pin and a signaling pin; and resisting means configured to be coupled to a battery identification resistor of a battery via the signalling pin. The apparatus further comprises an interface with at least one power pin and a battery identification pin, and detection means configured to detect a resistance associated with the battery identification pin and to determine, based on the detected resistance, whether an accessory is attached to the apparatus.

### TECHNICAL FIELD

The present invention relates to signalling between an accessory and an apparatus. Further, the invention relates to a method, a system and a computer program product for the same.

### BACKGROUND

Wireless charging is an application where electromagnetic induction is used to transfer energy over air. A wireless charging system comprises a charger device i.e. a power transmitter with a primary coil, and a device to be charged i.e. a power receiver with a secondary coil. The current in the charger device is transferred to the charged device through these electromagnetically coupled coils, and the induced current may be further processed and used to charge the battery of the charged device. Energy is transmitted through inductive coupling from the charger device to the charged device, which may use that energy to charge batteries or as direct power.

A trend in today's charger devices, e.g. in charger devices of portable electronics, is a battery-operated and wireless inductive charger device. These charger devices are suitable to be used in various surroundings without a need to find an electric wall socket for an electric cable of the charger and without a need to connect portable electronics to the charger by a wire.

Wireless charging implementation with today's solutions is relatively high-priced for low-end smartphones.

### SUMMARY

Now there has been invented an improved method and technical equipment implementing the method which can be utilized e.g. for wireless charging. Various aspects of the invention include a method, an apparatus, a system and a computer readable medium comprising a computer program stored therein, which are characterized by what is stated in the independent claims. Various embodiments of the invention are disclosed in the dependent claims.

According to a first aspect, there is provided an apparatus comprising an interface with at least one power pin and a signalling pin, resisting means configured to be coupled to a battery identification resistor of a battery via the signalling pin, wherein the resisting means is configured to indicate data by causing a change of a voltage across the battery identification resistor of the battery.

According to a second aspect, there is provided a computer program product embodied on a non-transitory computer readable medium, comprising computer program code configured to, when executed on at least one processor cause an apparatus, having an interface with at least one power pin and a signalling pin and having resisting means configured to be coupled to a battery identification resistor of a battery via the signalling pin, to indicate data by causing a change of a voltage across the battery identification resistor of the battery.

According to a third aspect, there is provided a method for signalling data, wherein an accessory comprises an interface with at least one power pin and a signalling pin, and resisting means configured to be coupled to a battery identification resistor of a battery via the signalling pin, wherein the method comprises indicating data from the resisting means by causing a change of a voltage across the battery identification resistor of the battery.

According to an embodiment, the resisting means comprises at least one resistor, wherein the resisting means is configured to be coupled parallel to the battery identification resistor, and wherein resistance of the at least one resistor indicates at least one parameter relating to an accessory.

According to an embodiment, a first value of the resistance indicates that the accessory is providing power to the power pin and a second value of the resistance indicates that the accessory is not providing power to the power pin.

According to an embodiment, the resisting means comprises several resistors configured to be coupled parallel to the battery identification resistor of the battery via the signalling pin, where each of the several resistors indicates at least one parameter relating to an accessory.

According to an embodiment, the accessory is a cover for a device.

According to an embodiment, the accessory comprises a wireless charger.

According to a fourth aspect, there is provided an apparatus comprising at least one processor, memory including computer program code, wherein the apparatus further comprises an interface with at least one power pin and a battery identification pin, detection means configured to detect a resistance associated with the battery identification pin and to determine, based on the detected resistance, whether an accessory is attached to the apparatus.

According to a fifth aspect, there is provided a computer program product embodied on a non-transitory computer readable medium, comprising computer program code configured to, when executed on at least one processor, cause an apparatus having an interface with at least one power pin and a battery identification pin, to detect a resistance associated with the battery identification pin and to determine, based on the detected resistance, whether an accessory is attached to the apparatus.

According to a sixth aspect, there is provided a method for determining parameters of an accessory by an apparatus, wherein the apparatus comprises an interface with at least one power pin and a battery identification pin, wherein the method comprises detecting a resistance associated with the battery identification pin; and determining based on the detected resistance, whether an accessory is attached to the apparatus.

According to an embodiment, the resistance of the at least one resistor indicates at least one parameter of the accessory.

According to an embodiment, a first value of the resistance indicates that the accessory is providing power to the power pin and a second value of the resistance indicates that the accessory is not providing power to the power pin.

According to an embodiment, the accessory is a cover for the apparatus.

According to an embodiment, the apparatus comprises display means for displaying a charging indication based on the detected resistance.

According to an embodiment, the accessory comprises a wireless charger being connected to the interface.

According to a seventh aspect, there is provided a system comprising an apparatus and an accessory, wherein the apparatus comprises at least one processor, memory including computer program code, wherein the accessory comprises an interface with at least one power pin and a signaling pin; and resisting means configured to be coupled to a battery identification resistor of a battery via the signalling pin, and wherein the apparatus further comprises an interface with at least one power pin and a battery identification pin, and detection means configured to detect a resistance associated with the battery identification pin and to determine, based on the detected resistance, whether an accessory is attached to the apparatus.

### DESCRIPTION OF THE DRAWINGS

In the following, various embodiments of the invention will be described in more detail with reference to the appended drawings, in which

FIG. 1 shows an example of an apparatus as a simplified block chart;

FIG. 2 shows an example of a layout of an apparatus;

FIG. 3 shows an example of interface between a battery and a transceiver;

FIG. 4 shows an example for smart cover detection using available BSI interface;

FIG. 5 shows an example for detection of several functions in a smart cover;

FIG. 6 shows an embodiment of a smart cover having additional battery;

FIG. 7 shows an embodiment of a cover being configured for wireless charging;

FIG. 8 shows an example of an interface between an apparatus and a WLC cover;

FIG. 9 shows an example of a simplified block diagram showing battery and BSI interface;

FIG. 10 shows an example of an apparatus and a back cover; and

FIG. 11 shows an example of a method in an apparatus as a flowchart.

### DESCRIPTION OF EXAMPLE EMBODIMENTS

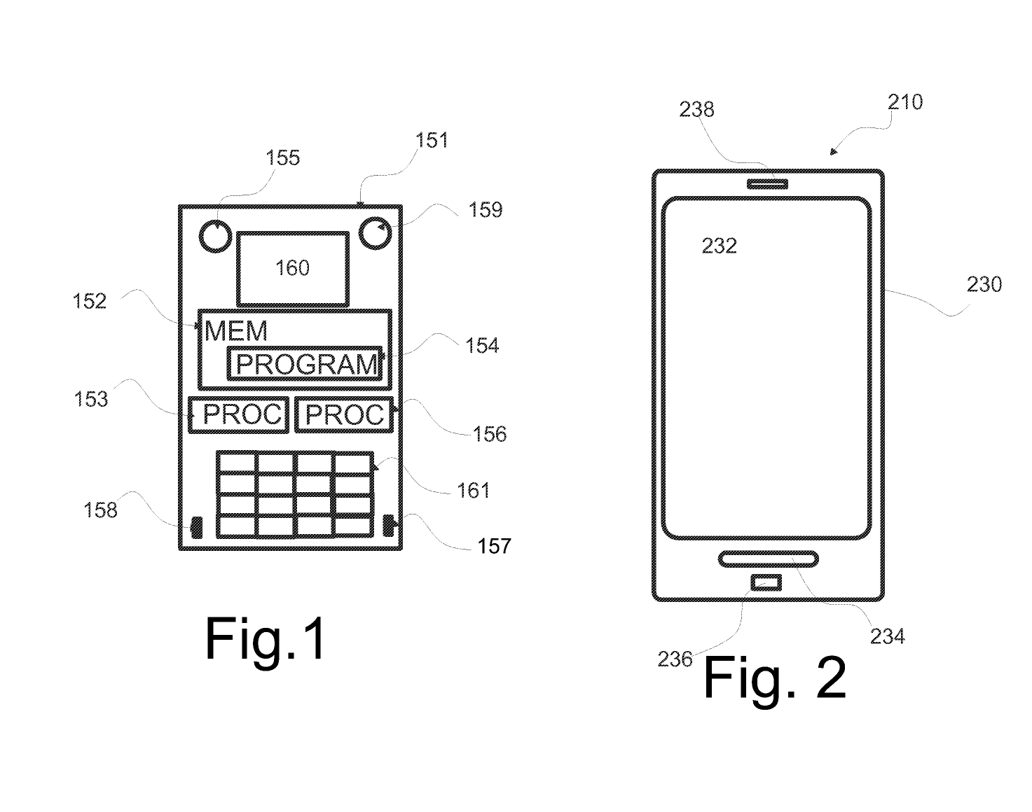

Example of an apparatus is illustrated in FIG. 1. The apparatus 151 contains memory 152, at least one processor 153 and 156, and computer program code 154 residing in the memory 152. The apparatus according to the example of FIG. 1, also has one or more cameras 155 and 159 for capturing image data, for example video. One of the cameras 155, 159 can be an IR (Infrared) camera, for example.

The apparatus may also contain one, two or more microphones 157 and 158 for capturing sound. The apparatus may also contain sensor for generating sensor data relating to the apparatus' relationship to the surroundings. The apparatus also comprises one or more displays 160 for viewing single-view, stereoscopic (2-view) or multiview (more-than-2-view) and/or previewing images. Anyone of the displays 160 may be extended at least partly on the back cover of the apparatus. The apparatus 151 also comprises an interface means (e.g. a user interface) which allows a user to interact with the apparatus. The user interface means is implemented either using one or more of the following: the display 160, a keypad 161, voice control, or other structures. The apparatus may be configured to connect to another device e.g. by means of a communication block (not shown in FIG. 1) able to receive and/or transmit information though a wireless or a wired network.

FIG. 2 shows a layout of an apparatus according to an example embodiment. The apparatus 210 is for example a mobile terminal (e.g. mobile phone, a smart phone, a camera device, a tablet device) or other user equipment of a wireless communication system. Embodiments of the invention may be implemented within any electronic device or apparatus, such a personal computer and a laptop computer.

The apparatus 210 shown in FIG. 2 comprises a housing 230 for incorporating and protecting the apparatus. The housing 230 is composed at least of a back cover. The apparatus 210 further comprises a display 232 in the form of e.g. a liquid crystal display. In other embodiments of the invention the display is any suitable display technology suitable to display an image or video. The apparatus 210 may further comprise a keypad 234 or other data input means. In other embodiments of the invention any suitable data or user interface mechanism may be employed. For example the user interface may be implemented as a virtual keyboard or data entry system as part of a touch-sensitive display. The apparatus may comprise a microphone 236 or any suitable audio input which may be a digital or analogue signal input. The apparatus 210 may further comprise an audio output device which in embodiments of the invention may be any one of: an earpiece 238, speaker, or an analogue audio or digital audio output connection. The apparatus 210 of FIG. 2 also comprises a battery. The apparatus 210 according to an embodiment may comprise an infrared port for short range line of sight communication to other devices. In other embodiments the apparatus 210 may further comprise any suitable short range communication solution such as for example a Bluetooth wireless connection, Near Field Communication (NFC) connection or a USB/firewire wired connection. The apparatus 210 according to an embodiment comprises a camera or is connected to one wirelessly or with wires.

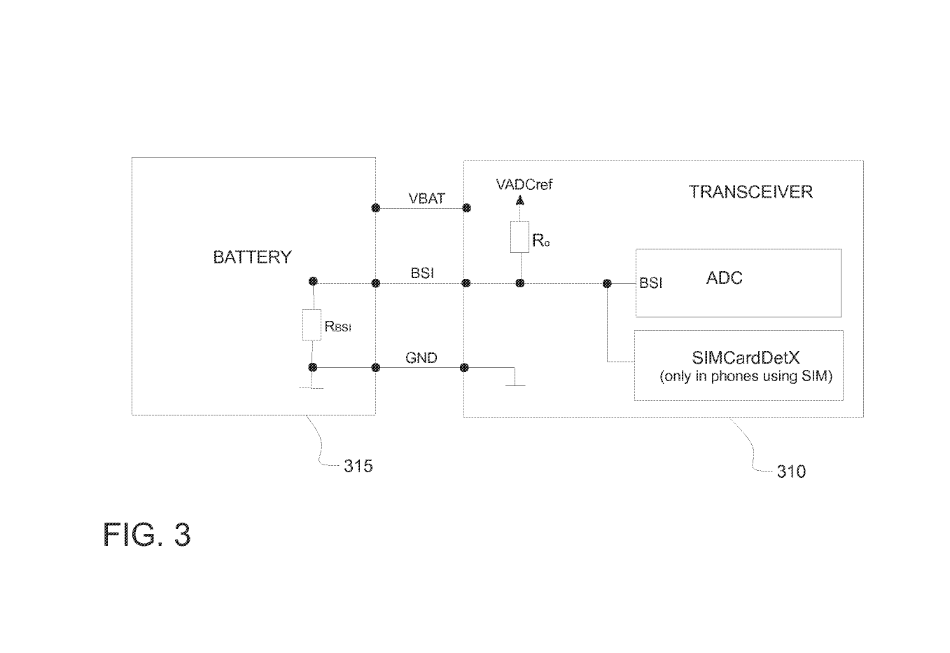

Battery size indicator (BSI) is an interface functionality used in mobile phones (i.e. transceiver) 310 for battery 315 type detection. This is based on resistor value. FIG. 3 illustrates a basic block diagram for the BSI connection. In here, connector “VBAT” is a power pin for battery voltage, connector “GND” is for ground and connector “BSI” is a signaling pin for battery size indicator. “ADC” stands for analog to digital converter and “VADCref” stands for ADC reference voltage.

The present embodiments are for implementing low cost WLC cover for an apparatus (such as a mobile phone, for example) that has only one power input in a power management IC. In the following, several embodiments of the invention will be described in the context of wireless charging (WLC) cover for an apparatus. It is to be noted, however, that the invention is not limited to WLC covers. In fact, the different embodiments include any functional cover for an apparatus, and where detection of properties of the cover is required.

According to embodiments, the BSI interface functionality is extended by connecting resistor(s) parallel to BSI interface. The apparatus is thus allowed to detect new accessory products when connected to that interface. Examples of the accessories and functionalities are for example a smart cover attachment, smart cover model/type, smart cover with N amount of functions/operations, smart cover with additional battery, smart cover with wireless charging capability.

For example, smart cover attachment may be detected from BSI interface. As another example, smart cover model/type with different resistor values connected parallel to BSI interface may be detected from BSI interface. As yet another example, smart cover may have N amount of different functions/operations and each function/operation can interact with the apparatus using the same BSI interface. Yet as further example, the cover or shell may have additional battery integrated. Yet as further example, the cover or shell may have wireless charging capability integrated and may charge the battery directly.

As mentioned as the last example, the shell/cover is configured to enable wireless charging. This is beneficial at least for low-end mobile phones. In such embodiment, the shell/cover is configured to charge phone's battery directly. Wireless charging functionality is implemented on a phone's cover/shell, and this cover/shell may be end-user changeable. The charging would occur when the battery is connected to the phone. In order to implement this, the wireless charging is connected to the phone's battery parallel to phone's battery charging circuitry. In addition, the phone comprises wireless charging enabler on base engine. The wireless charging enabler may be generalized to include also the additional power pin (VBAT), ground (GND), and signalling pin (BSI) contacts for the cover/shell. The phone may also include means to control the wireless charging functionality of the shell/cover, for example by an enable or disable signal.

The different examples utilizing the present idea are disclosed next.

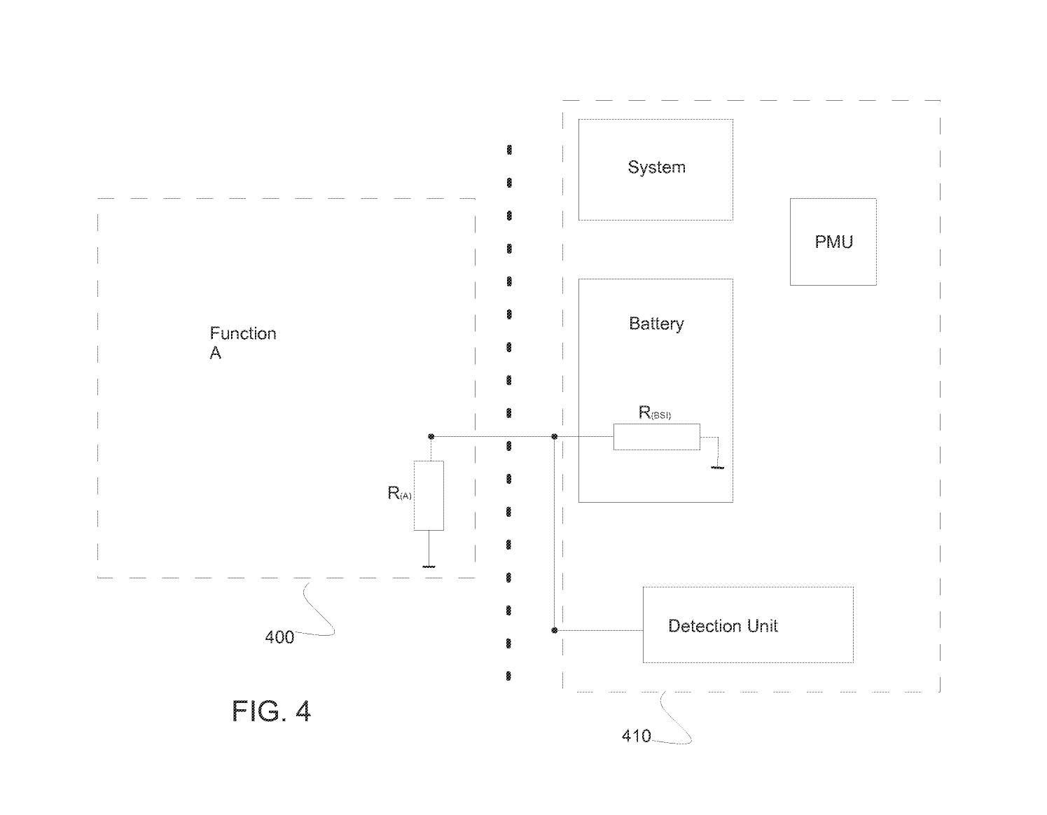

FIG. 4 illustrates an embodiment for smart cover detection using available BSI interface. In addition, the cover model and/or type can also be detected if different models/types have different resistor values R(A). Detection is carried from apparatus's existing BSI interface that is used for battery type detection (see FIG. 3). For example, the color of the cover may be indicated with resistor value A, after which the apparatus can adjusts screen theme to that color. In FIG. 4 there is illustrates a smart cover/shell 400 with a function A (resistor value A, R_{(A)}). The apparatus 410 comprises the battery and a detection unit for detecting the battery type R_{(BSI)} and the cover being attached R_{(A)}. In addition the apparatus 410 comprises a power management unit (PMU) functioning at least for system power management, battery charging and charging interface.

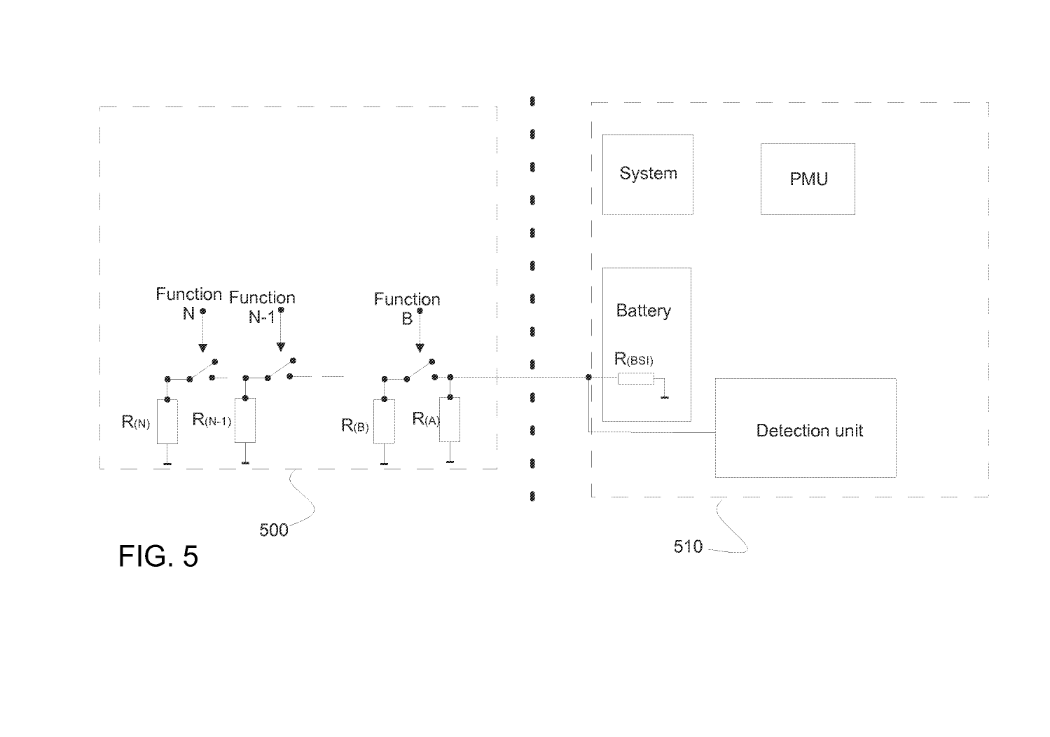

FIG. 5 illustrates an embodiment, where smart cover/shell has more functions/operations than in FIG. 4. Each of the functions may interact with the apparatus by using the same BSI interface. The smart cover/shell 500 comprises—in addition to function A (R_{(A)})—a function B (R_{(B)}), . . . , a function N−1 (R_{(N-1)}) and a function N (R_{(N)}). The detection unit of the apparatus 510 is thus configured to detect the battery type (R_{(BSI)}), cover being attached (R_{(A)}), the function B, . . . , the function N−1 and the function N. The smart cover functions may be also indicated by a combination of resistances R_{(A)} to R_{(N)}. Such combination may be implemented for example by arranging two or more of the resistances R_{(A)} to R_{(N)} in parallel or series or in a combination of parallel and serial resistances. The apparatus 510 further comprises a power management unit (PMU) functioning at least for system power management, battery charging and charging interface.

In the embodiment of FIG. 5, the first function may be the one presented with FIG. 4, where the cover's color is indicated with resistor value A, according to which the apparatus is able to adjust the screen theme color. The second function (B) can be e.g. a flip cover indication. Such flip cover indication is configured to indicate whether a protective lid is on or off the screen. The resistor's R_{(B)} parallel connection indicates whether the protective lid is on, whereby the apparatus is able to switch display off to save power; and whether it is indicated that the protective lid is off, the apparatus is able to switch the display on again.

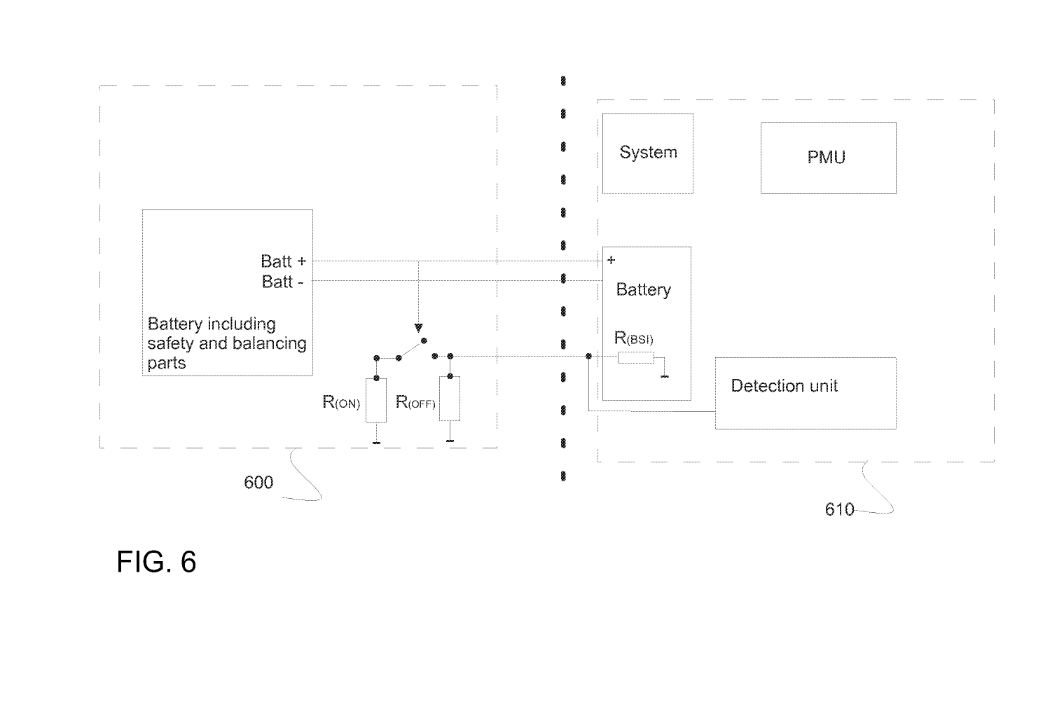

FIG. 6 illustrates an embodiment with smart cover 600 having additional battery. As is realized from FIG. 6, the cover/shell 600 has an integrated battery, which is additional to the battery of apparatus 610. The resistors are configured to indicate whether the additional battery is on R_{(ON)} or off R_{(OFF)}, that is whether the additional battery is providing power to the power pin (Batt+/Batt−). If the additional battery is not connected, R_{(BSI)} is the resistor value of the apparatus's battery, e.g. 100 kΩ in BL-4U battery. When the additional battery is connected safely, the apparatus's battery capacity may be doubled. The detection unit of the apparatus 610 is configured to detect the battery type, the cover being attached and the battery being connected.

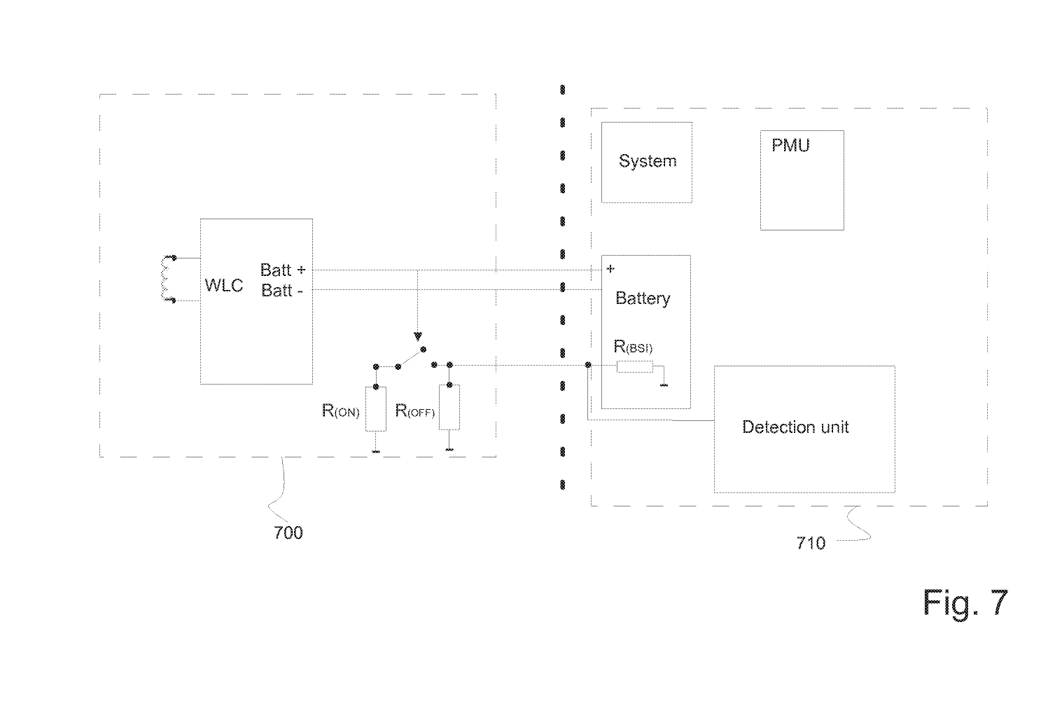

FIG. 7 illustrates an embodiment, where the cover/shell 700 is configured for wireless charging (WLC). Resistor R_{(OFF)} indicates whether the WLC circuit is attached. Cover/shell 700 may be configured to change the resistance (or impedance) that is coupled parallel to resistor R_{(BSI)} based on the charging state of the WLC circuit. For example, supplying power from the WLC circuit may cause a switch to connect resistor R_{(ON)} in parallel with R_{(ON)} and R_{(BSI)}, as shown in FIG. 7. In another example (not shown), the resistor R_{(ON)} may be connected in series with resistor R_{(OFF)}. Based on this, the apparatus 710 is able to show correct charging indication to the user. If there is no battery cover/shell connected, R_{(BSI)} is the resistor value of the apparatus's battery, e.g. 100 kΩ in BL-4U battery. On the other hand, if there is battery cover/shell connected, but it is not charging wirelessly, R_{(BSI)} is the resistor value of the apparatus's battery e.g. 100 kΩ in BL-4U battery and in parallel there is also R_{(OFF)} e.g. 20 kΩ. Now, the resistor value being measured by the apparatus 710 is about 16.67 kΩ. This resistor value has been obtained by:

$$R = \frac{1}{\frac{1}{{R}_{( BSI )}} + \frac{1}{{R}_{( OFF )}}} .$$

In addition, if the cover's 700 battery is connected but charging wirelessly, R(BSI) is a resistor value of the apparatus's 710 battery, e.g. 100 kΩ in BL-4U battery, and in parallel there is also R_{(OFF)} e.g. 20 kΩ and now also in parallel there is R_{(ON)} e.g. 100 kΩ. The resistor value being measured by the apparatus is about 14.3 kΩ. This resistor value has been obtained by:

$$R = \frac{1}{\frac{1}{{R}_{( BSI )}} + \frac{1}{{R}_{( OFF )}} + \frac{1}{{R}_{( ON )}}} .$$

The detection unit of the apparatus 710 is configured to detect the battery type, the WLC cover being attached and whether the WLC power is ON/OFF.

Although embodiments of the invention are described using resistors as an example, the resistors may be generalized to include any resisting means such as current sources or other components capable of adjusting the amount of current through the signaling (BSI) pin.

According to an example, the wireless charging cover can replace the existing battery back cover. The wireless charging cover may have e.g. bq51050B charge controller sold by Texas Instruments, which is direct Li-Ion charge controller device for wireless power transfer. For safety, the charge control may also have its own, independent thermal sensing for the battery temperature. Depending on the charging circuitry and thermal monitoring capability, the charging voltage and temperature may need to be limited to only certain temperature area (e.g. 4.1V from 0° C. to +45° C. Then, for example, it might not be allowed to have battery charged full in extreme temperatures. Thus WLC cover is configured to charge directly the apparatus's battery independently. There is no need to connect the WLC cover to apparatus's PMU (charging circuitry). Therefore WLC shell can connect parallel to apparatus's battery (directly into battery's +/− contacts).

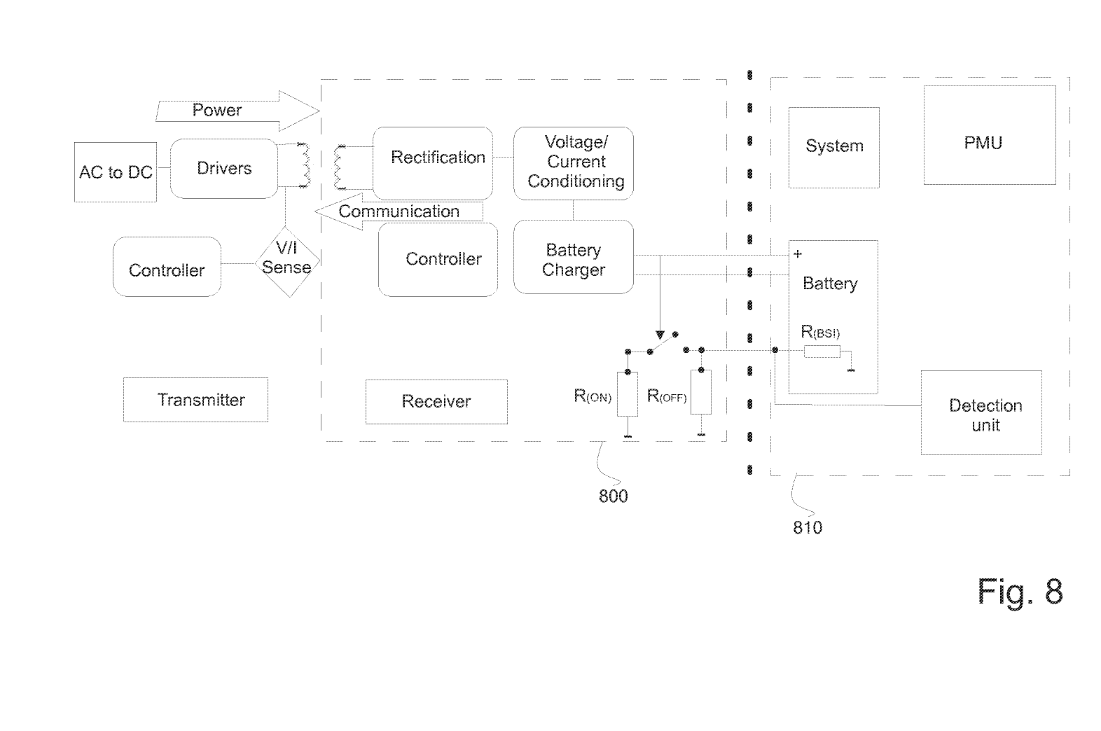

The interface between phone and the WLC cover is illustrated in FIG. 8. It is appreciated that the BSI parallel connection enables simple, reliable and low cost way to tell to the apparatus when WLC cover/shell is in place, and then also when the charging is ongoing. FIG. 8 illustrates the apparatus 810 and the smart cover 800.

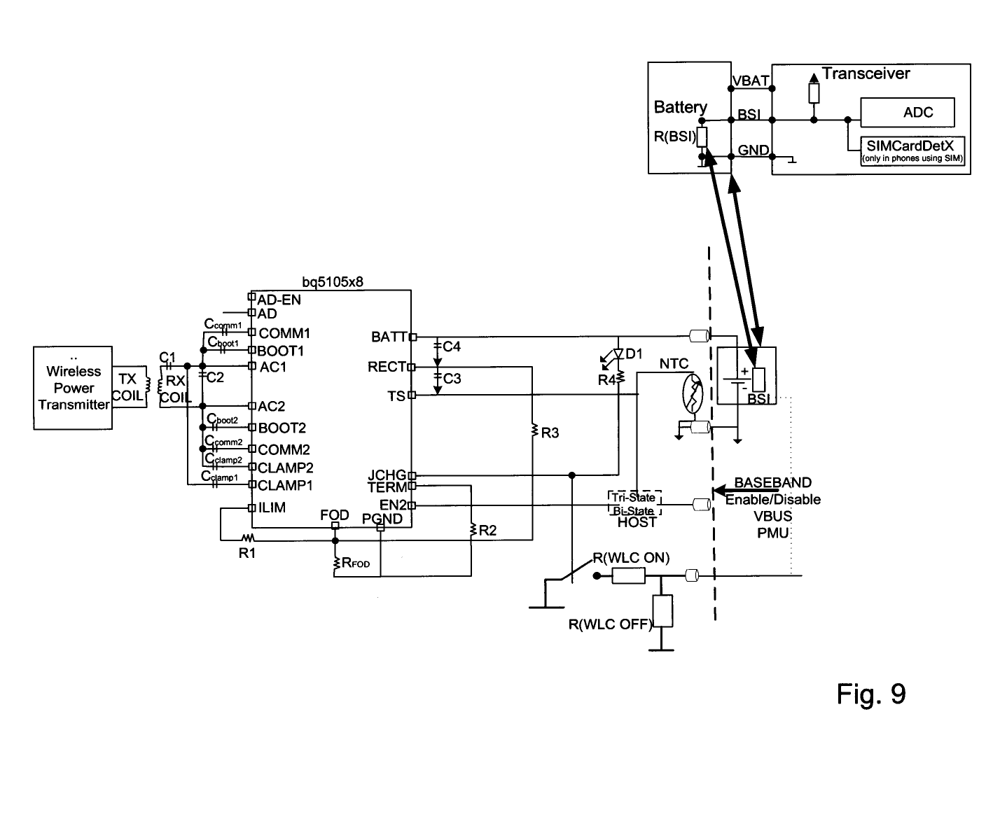

FIG. 9 further illustrates simplified block diagram showing battery +/− and BSI interface. Charging enable/disable control is shown in FIG. 9, where apparatus's baseband engine has enable/disable control from phone to WLC shell. This means that WLC charging is terminated if apparatus's baseband engine so decides. Triggers for that can be e.g. VBUS is active (i.e. USB charging is ongoing) or baseband engine is heating up during video display, navigation or any other process that consumes lot of power and thus generates heat. In such situation, the temperature of the operating system or the surface of the apparatus or the battery is reaching the maximum value. Thus, the apparatus can decide to disable wireless charging.

In addition to the wireless charging—and as was described earlier—there is a possibility to authenticate original accessories with the present embodiments. By this, only certain model or models may be allowed, while the others are disallowed. In addition, cover/shell resistor value can inform other parameters as well, which would affect to performance normalization like magnetometer, IHF speaker, antennas, etc. Further, the original accessory may be authenticated.

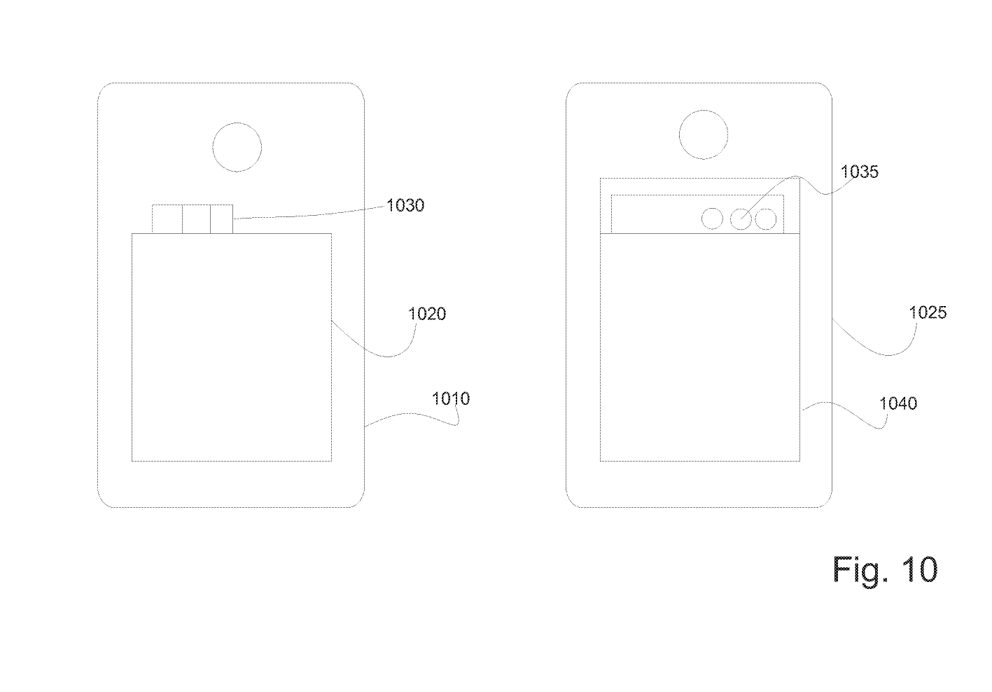

In the apparatus, the interface contacts may be visible when the cover/shell is removed, see FIG. 10 showing an apparatus 1010 without the back cover 1025 and having a battery 1020 and the interface contacts 1030, the interface contacts comprising at least a power pin and a battery identification pin. The interface contacts may also be invisible. The back cover 1025 in this example is a WLC shell comprising a wireless charger 1040 and connections 1035 to apparatus's battery interface 1030. The connections comprise at least a power pin and a signalling pin.

The charging indication for the wireless charging in apparatus's user interface can be implemented similarly as for the wired charging, even if the wireless charging is implemented outside the power management unit and the current does not go through the battery gauge. Because the apparatus knows that it is being charged wirelessly, and there is a battery voltage measurement and a current measurement, this information can be used to detect wireless charging from shell side. Thus, it is possible to indicate the charging also when the current does not go through the battery gauge. Alternatively, the wireless charging indication can be implemented with additional charging indicator LED (Light Emitting Diode) being integrated into wireless charging accessory cover.

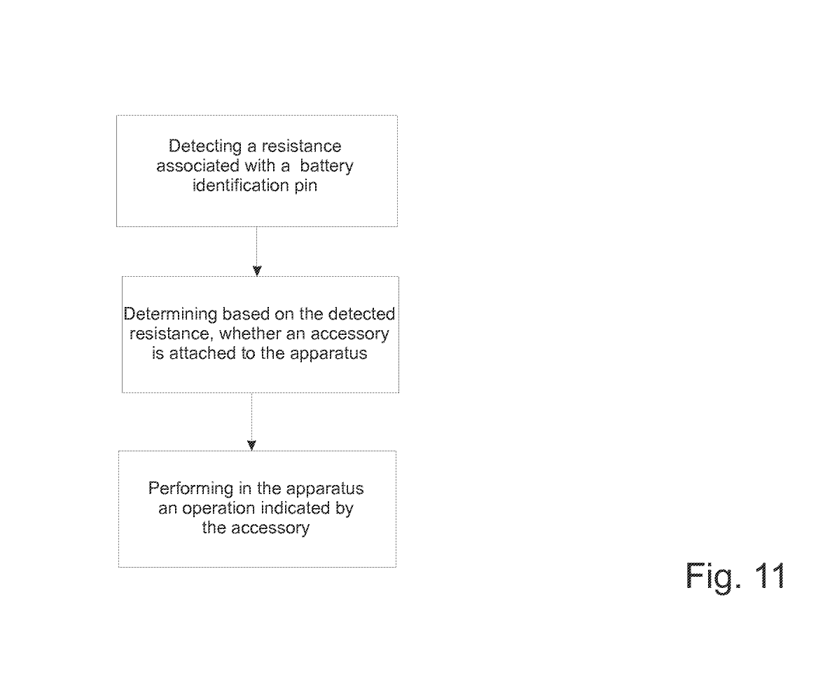

FIG. 11 illustrates a flowchart representing an example of a method executed in an apparatus. In the method a resistance associated with a battery identification pin is detected. The detected resistance is used for determining whether an accessory is attached to the apparatus. The apparatus then carries out any operation that is indicated by the accessory. The operation may be any of the examples disclosed with reference to FIGS. 4, 5, 6, 7.

The various embodiments may provide advantages. For example, due to the wireless charger enabler on the phone, there is no need to have Mux IC (Multiplexer Integrated Circuit) and other components in the phone, whereby the cost of the phone can be decreased in terms of wireless charging. In addition, there is less heat in phone's baseband engine. As charging is completely done by WLC (Wireless

Charging) shell, losses are not generated in the baseband PMU (Power Management Unit). In addition, there is a possibility for original accessory authentication. For example, it is possible to authenticate WLC shell is using the battery BSI interface. Due to that, the BSI can inform the colour of the shell to the phone, the BSI can inform other parameters as well (e.g. performance normalization like magnetometer, IHF speaker, antennas, etc.), the original accessory may be authenticated and in future also normal vs. high voltage cell may be informed or controlled. As a further advantage, the same interface can be used to make low cost battery shell.

The various embodiments of the invention can be implemented with the help of computer program code that resides in a memory and causes the relevant apparatuses to carry out the invention. For example, an apparatus may comprise circuitry and electronics for handling, receiving and transmitting data, computer program code in a memory, and a processor that, when running the computer program code, causes the device to carry out the features of an embodiment.

It is obvious that the present invention is not limited solely to the above-presented embodiments, but it can be modified within the scope of the appended claims.

1-13. (canceled)

14. An apparatus comprising:
an interface with at least one power pin and a signalling pin;
at least one resistor configured to be coupled to a battery identification resistor of a battery of another apparatus via the signalling pin, wherein the at least one resistor is configured to indicate data by changing a resistance of the at least one resistor based on a charging state of the apparatus to cause a change of a voltage across the battery identification resistor of the battery, wherein a first value of the resistance indicates that the apparatus is providing power to the power pin and a second value of the resistance indicates that the apparatus is not providing power to the power pin.

15. An apparatus according to claim 14, wherein the at least one resistor is configured to be coupled parallel to the battery identification resistor, and wherein resistance of the at least one resistor indicates at least one parameter relating to an accessory.

16. An apparatus according to claim 14, wherein the at least one resistor comprises several resistors configured to be coupled parallel to the battery identification resistor of the battery via the signalling pin, where each of the several resistors indicates at least one parameter relating to an accessory.

17. An apparatus according to claim 15, wherein the accessory is a cover for a device.

18. An apparatus according to claim 15, wherein the accessory comprises a wireless charger.

19. An apparatus comprising at least one processor, memory including computer program code, wherein the apparatus further comprises an interface with at least one power pin and a battery identification pin, and wherein the apparatus is configured to:
detect a resistance associated with the battery identification pin and to determine, based on the detected resistance, whether an accessory is attached to the apparatus, wherein a first value of the resistance indicates that the accessory is providing power to the power pin and a second value of the resistance indicates that the accessory is not providing power to the power pin; and
a display a charging indication based on the detected resistance.

20. An apparatus according to claim 19, wherein the accessory is a cover for the apparatus.

21. An apparatus according to claim 19, wherein the accessory comprises a wireless charger being connected to the interface.

22. A method for signaling data, wherein an accessory apparatus comprises an interface with at least one power pin and a signaling pin, and at least one resistor configured to be coupled to a battery identification resistor of a battery of another apparatus via the signaling pin, wherein the method comprises indicating data by changing a resistance of the at least one resistor based on a charging state of the accessory apparatus to cause a change of a voltage across the battery identification resistor of the battery, wherein a first value of the resistance indicates that the accessory apparatus is providing power to the power pin and a. second value of the resistance indicates that the accessory apparatus is not providing power to the power pin.

23. A method comprising:
detecting a resistance associated with a battery identification pin of an apparatus;
determining, based on the detected resistance, whether an accessory is attached to the apparatus, wherein a first value of the resistance indicates that the accessory is providing power to a power pin of the apparatus and a second value of the resistance indicates that the accessory is not providing power to the power pin; and
displaying a charging indication based on the detected resistance.
